(19) United States
(12) Patent Application Publication
(10) Pub. No.: US 2006/0123443 A1
(43) Pub. Date: Jun. 8, 2006

(54) Inserting local signals during channel changes

(75) Inventors: Jeffrey S. Hamilton, Doylestown, PA (US); Gregory C. Flickinger, Furlong, PA (US)

Correspondence Address: TECHNOLOGY, PATENTS AND LICENSING, INC./PRIME, 2003 SOUTH EASTON RD, SUITE 208, DOYLESTOWN, PA, 18901, US

(73) Assignee: Prime Research Alliance E, Inc.

(21) Appl. No.: 11/290,099

(22) Filed: Nov. 30, 2005

Related U.S. Application Data
(63) Continuation of application No. 09/751,349, filed on Dec. 28, 2000, now abandoned.

(51) Int. Cl. H04N 7/10; H04N 7/16; H04N 7/025

(52) U.S. Cl. 725/32; 725/151

(57) ABSTRACT

An apparatus and a method for inserting and displaying one or more signals during processing and display delays encountered in digital STB-receivers, including those delays encountered during channel changes. Moreover, a means for increasing the channel change delay period, while maintaining subscriber satisfaction, and thereby freeing up bandwidth for other services, is provided. These signals can be advertisements, entertainment, or other messages. When a channel change request occurs on a digital set-top receiver, a local watchdog module detects the channel change event and causes to be generated a signal that is immediately displayed on the TV, while the MPEG-2 subsystem of the receiver acquires, stores, decodes and presents the new program to the television. Providing advertisements or entertainment during the delay period allows for increase in the delay period thus allowing for higher compression and increased availability of bandwidth.

### CROSS REFERENCE TO RELATED APPLICATION

This application is a continuation of co-pending patent application Ser. No. 09/751,349, filed Dec. 28, 2000, and entitled “Inserting Local Signals during MPEG Channel Changes,” the entire disclosure of which is herein incorporated by reference.

### BACKGROUND OF THE INVENTION

Delivering television programs in a digital format provides many advantages. Quality is improved because transmission noise does not accumulate in the picture or sound signals, providing cleaner video and audio. The ability to compress the digital information allows for the delivery of multiple programs over the same bandwidth traditionally used for only one analog program, thus providing viewers and operators with more programming choices. Also, additional services can be added for data broadcasting and interactivity. The MPEG-2 standard was developed, inter alia, to address the delivery of digital video, and to facilitate the development of interoperable components from different manufacturers. The MPEG-2 standard specifies the syntax of encoded audio and video as well as the requirements for time-multiplexing several programs and other data into a single digital stream. Standards document ISO/IEC-13818 is incorporated by reference herein.

Digital television can be distributed over a variety of systems including satellite, terrestrial, and cable. An example of a satellite system is shown in FIG. I a and an example by which an MPEG-2 transport stream (TS) is formed is shown in FIG. 1b. In a typical example such as this, the audio, video (and other components) of a program are compressed at the source and time-multiplexed with other programs. System Information (SI) and Program Specific Information (PSI) needed to interpret the TS are also added to the multiplex. This digital multiplex is modulated and transmitted to a satellite, which then broadcasts the modulated signal to an antenna on the subscriber's residence. As illustrated in FIG. 1B, in a typical MPEG system a video source may comprise an A/D converter 101, an MPEG video encoder 103, a packetizer 105 and a stream multiplexer (mux) 107. The A/D converter 101 changes analog video to digital video, the MPEG-2 video encoder 103 creates elementary streams, the packetizer 105 packetizes the streams. Similarly an audio source includes an A/D converter 109, MPEG audio encoder 111 (or audio compression encoder, and a packetizer 113. These packetized elementary streams (PES) are then put into a transport stream mux 115 along with SI and PSI data. The transport stream mux 115 generates transport streams that can be modulated and delivered over a variety of television systems to subscriber homes.

FIG. 2 illustrates the structure of a transport-stream packet. Each packet is 188 bytes long, including the header and payload. An important field in the header is the program ID (PID). Every audio, video, and data PES in a transport stream has a unique PID. A transport stream's PAT, which is always located in PID 0, contains a listing of which PIDs contain the program map tables (PMTs). The PMTs describe the programs in the transport stream by providing a listing of the video and audio PIDs that make up a particular program—such as 1431 and 1432. The PMT also tells the decoder which PID contains the program clock reference (PCR) for each program.

At the subscriber residence, a receiving antenna is connected to a receiver, or set-top box, typically proximate to a television. The set-top box (STB) (or other receiver) selects and demodulates the signal to recover the MPEG multiplexes. The STB extracts the program that the subscriber requests (i.e., tunes to), and decodes the compressed audio and video (and other appropriate date) for presentation to the subscriber on the television (TV). The method by which the signal can be broadcast and delivered to subscribers is not limited to satellite but includes widely utilized techniques including conventional cable systems (e.g., hybrid fiber-coax (HFC) systems) and terrestrial broadcast techniques, as well as newer techniques such as very high speed digital subscriber lines (VDSL) used in switched digital video (SDV) systems.

A digital television set-top box (STB) or more generally, a receiver, comprises an MPEG-2 subsystem that demultiplexes the transport stream and decodes the audio and video components which are then displayed on an output device (e.g., TV). FIG. 3 shows a schematic of a typical receiver illustrating these functional components. The subsystem processes the transport stream which contains all of the components necessary to decode and play one or more programs. Specifically, for each program there is at least one compressed video stream, one compressed audio stream, and associated system data to allow navigation and synchronization of the output. Additional system information, including program guides data, conditional access controls, and data downloads for interactive applications may also be present.

With reference to FIG. 3, the transport demultiplexer, or Demux, monitors the transport stream to establish packet boundaries so that the data fields may be processed. Then, based on instructions from one or more resident or host applications (e.g., a channel change command), the demultiplexer filters the packets from the incoming transport stream into the video and audio streams for a given program, and also extracts the system data. The audio and video compressed data streams are then sent to the audio and video decoders, respectively. The system information is sent to the processor memory for use by the host application in constructing navigation tables, conditional access information, and other applications such as electronic program guides.

The video and audio decoders function similarly. Each accepts the appropriate compressed video or audio data stream from the Demux, processes the stream (e.g., removes overhead such as control and synchronization data), and then decodes the data to reconstruct the digital video and audio data. Utilizing the timing information in the packet header, the uncompressed samples are forwarded to a digital-to-analog converter for playback through the television. The video signals must, of course be encoded into appropriate television format (e.g., NTSC) for playback on the TV.

In applications such as the satellite, cable, and SDV systems mentioned earlier, transport streams are broadcast or “pushed” to the receiver device. Because no regulation of the delivery rate is possible, a stream of data must be processed in real-time as it arrives. The MPEG-2 transport stream includes program clock references (PCR) that are extracted by the Demux to control and adjust the clock rate of the MPEG-2 receiver system. Clock rate adjustment is necessary to ensure that the decoders consume the incoming data at a rate that prevents the buffers from overflowing or underflowing.

Initially, the demultiplexer synchronizes with the incoming stream by finding the packet boundaries. The Demux is configured such that it captures a series of tables, program-specific information (PSI), that provide the basic program-mapping information necessary to determine which programs are in the multiplex and what packets make up a given program. When the viewer selects a program of interest with the remote control, a resident host application translates the selection into the appropriate configuration information for the Demux. The Demux then filters and forwards the required audio and video streams to the decoders. The video and audio decoders process the data sent by the demultiplexer to establish video and audio sequence boundaries respectively, and to extract the control information describing what parameters to use for decoding the data. The decoders also extract the timing information presentation time stamps (PTSs) that indicates when a reconstructed frame should be output. This ensures that the audio and video portions of the program are synchronized with each other. When all of the necessary information is available, the decoders decompress the respective streams and send the output to the television. All of this processing requires time that may ultimately introduce significant delays in the displaying the desired program to the viewer. This can be particularly noticeable and annoying during channel changes.

In traditional analog television receivers, the time required to change channels is minimal, because the audio and video data can be presented immediately after the tuner changes frequencies. The time required to change programs (i.e., channels) in a digital system, as described above, is inherently longer, because the new stream must be acquired, stored, decoded, and then presented. The time required to change channels ranges from one half of a second to two seconds depending on the implementation and the stream. As the channel-change time increases, it becomes noticeable to the viewer. These channel change delays are somewhat wasteful of resources, in that nothing is displayed during the delay, and can be quite annoying to the viewer.

Currently, channel changes to digital channels are slow and annoying to the viewer. A great deal of effort and transmission bandwidth is expended to minimize this problem. MPEG picture headers, I-frame or progressive refresh, PSI tables, etc. are all carried at a much higher rate than would be acceptable if rapid channel acquisition were not a priority. Typical refresh times of ½ to 1 second are currently required to provide acceptable acquisition, channel change performance. Meeting this requirement consumes approximately 20% of total transmission and storage capacity.

For the foregoing reasons, there is a need for a method whereby the delay during channel changes, and associated blank display, can be filled with something of interest to the viewer. There is also a need for a method whereby the channel change delay can actually be increased while still maintaining or increasing the satisfaction of the viewer, such that bandwidth, presently used for minimizing the delay period can be reallocated for other purposes.

### BRIEF SUMMARY OF THE INVENTION

The present invention discloses an apparatus and a method for inserting and displaying one or more signals during processing and display delays encountered in digital STB-receivers, including those delays encountered during channel changes. Moreover, the invention provides a means for increasing the channel change delay period, while maintaining subscriber satisfaction, and thereby freeing up bandwidth for other services.

In accordance with the principles of the present invention, and according to one embodiment, when a channel change request occurs on a digital set-top receiver, a local watchdog module detects the channel change event and causes to be generated a signal that is immediately displayed on the TV, while the MPEG-2 subsystem of the receiver acquires, stores, decodes and presents the new program to the television. In one embodiment, the signal displayed is overwritten (or terminated) as soon as the new program can be displayed by the subsystem. In another embodiment, the display of the newly tuned to program is delayed until the local signal is terminated.

In a preferred embodiment, the signals are local signals, stored on a hard drive or other storage (e.g., FLASH) of the set-top box (STB). In another embodiment, the signals are generated remotely from the STB, such as in the form of streaming media from the Internet. In yet another embodiment, the signal is carried in the transport stream, and is decoded and buffered, ready for immediate display at the delay event. In yet another embodiment, the signals are carried in the vertical blanking interval (VBI) of conventional analog broadcast television, and the receiver processor decodes and displays one or more of these signals during the delay.

In a preferred embodiment, the inserted signal includes one or more advertisements. In another embodiment, the signals are targeted advertisements.

In another embodiment the signals displayed are animations or other entertainment that may or may not include advertising.

In another embodiment, the signals can be selected by the subscriber, or customized by the subscriber through a subscriber interface such as the interactive program guide (IPG).

In one embodiment, the signals generated are in the form of a prioritized ad queue comprising static images, dynamic applets, animations and the like. In this embodiment, the ads in the ad queue may be ordered or prioritized for display depending on a variety of factors, including which channel is being tuned to or tuned from, which programming ad was recently displayed, etc. In an alternate embodiment, the ads that are inserted and displayed during the delay period are linked or correlated with other ads, for example, those ads appearing in the programming on the channel from which the channel change is made. Such linking of IPG and programming ads is described in detail in Applicant's co-pending application Ser. No. 09/749,255, filed on Dec. 27, 2000, entitled “Scheduling and Linking IPG Ads in Conjunction with Programming Ads in a Television Environment”, which is herein incorporated by reference.

According to one objective of the invention, by entertaining the viewer during the current channel change delay, the present invention allows for longer refresh times (i.e., delays), which may allow for a significant improvement in compression efficiency. Thus providing a “seamless” channel change experience to the viewer and an opportunity to present advertisements, while reallocating bandwidth for additional services. This would also make channel surfing slower, which may please advertisers without causing annoyance to the viewers. Slower channel surfing may encourage viewers to rely on an Interactive Program Guide (IPG) more often, thus presenting additional advertising impressions for content included on the IPG screens.

These and other features and objects of the invention will be more fully understood from the following detailed description of the preferred embodiments which should be read in light of the accompanying drawings.

### BRIEF DESCRIPTION OF THE SEVERAL VIEWS OF THE DRAWINGS

The accompanying drawings, which are incorporated in and form a part of the specification, illustrate the embodiments of the present invention and together with the description serve to explain the principles of the invention.

In the Drawings:

FIGS. 1A-B show examples of how digital video is delivered to subscribers and of how an MPEG-2 transport stream is formed;

FIG. 2 illustrates the structure of a transport-stream packet;

FIG. 3 shows schematic of a typical MPEG-2 receiver illustrating functional components;

FIG. 4 shows the process of decoding an MPEG transport stream;

FIG. 5 illustrates an exemplary block diagram of a set-top box according to one embodiment of the invention; and

FIG. 6 illustrates an exemplary flowchart for inserting signals into the MPEG program.

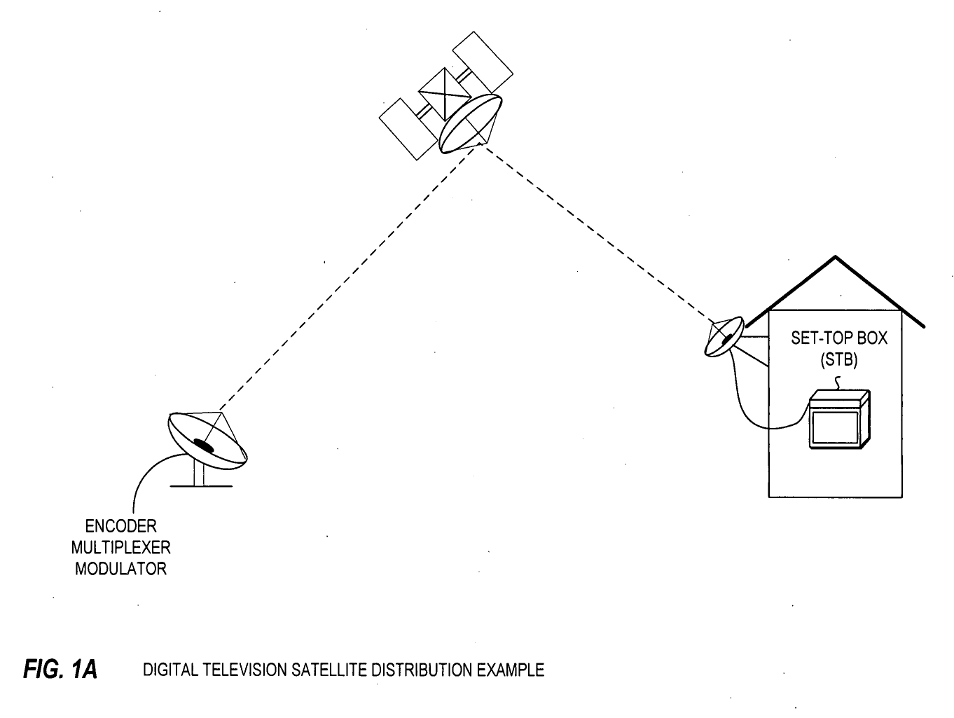

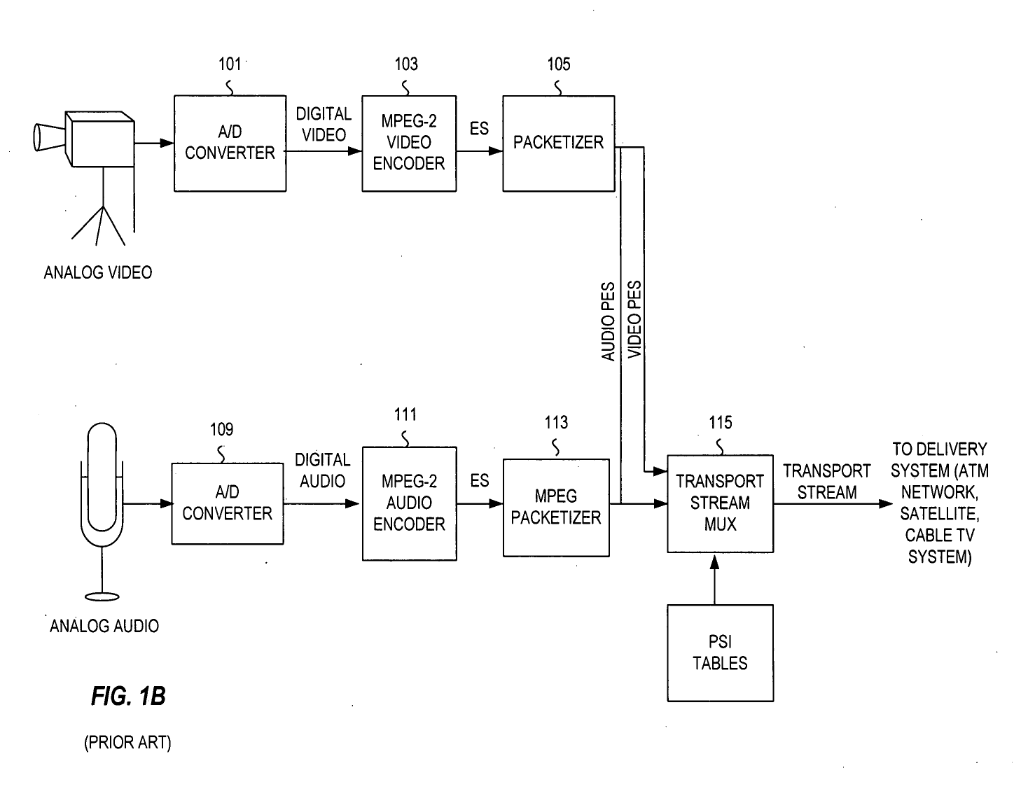

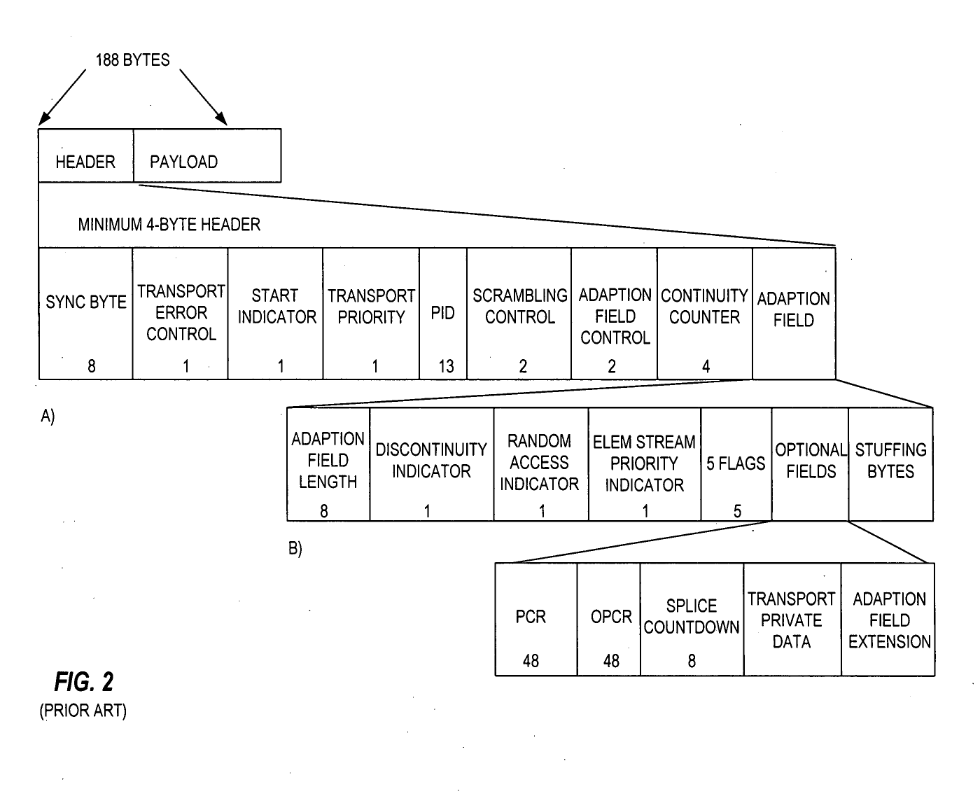

### DETAILED DESCRIPTION OF THE INVENTION

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

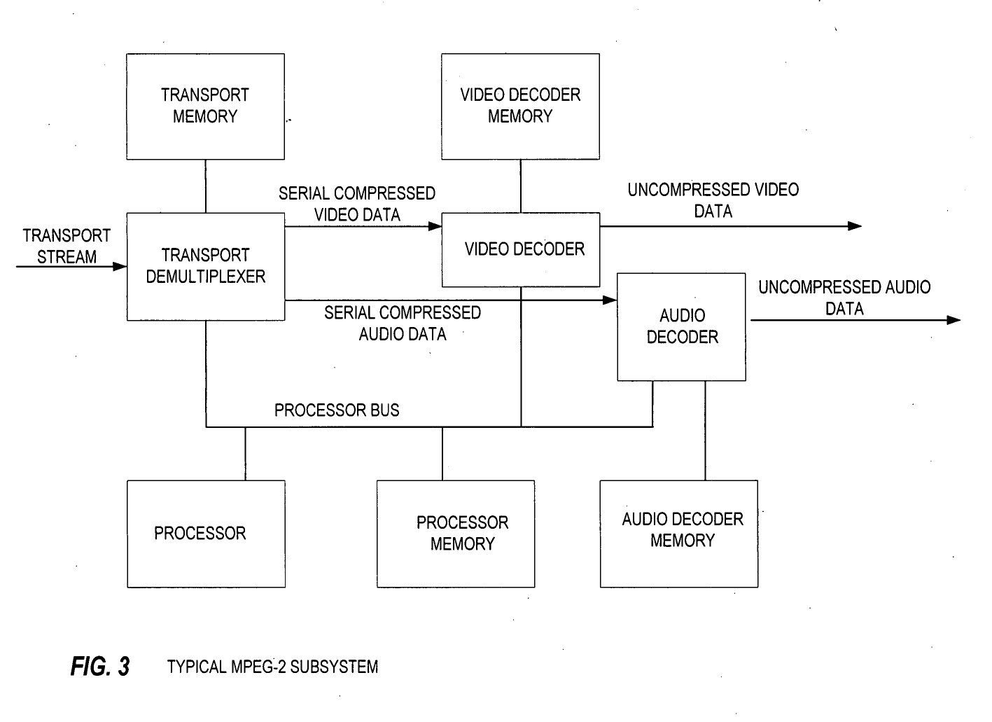

With reference to the drawings, in general, and FIGS. 3 through 6 in particular, the apparatus of the present invention is disclosed.

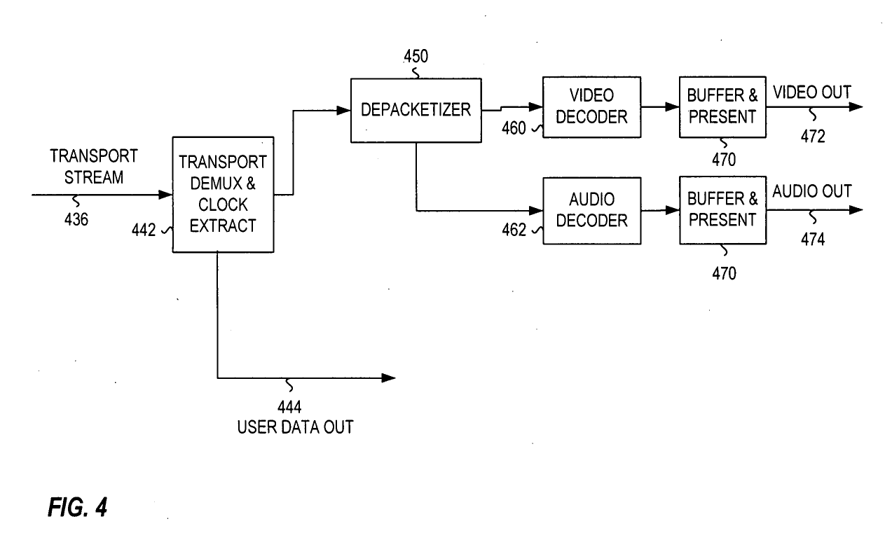

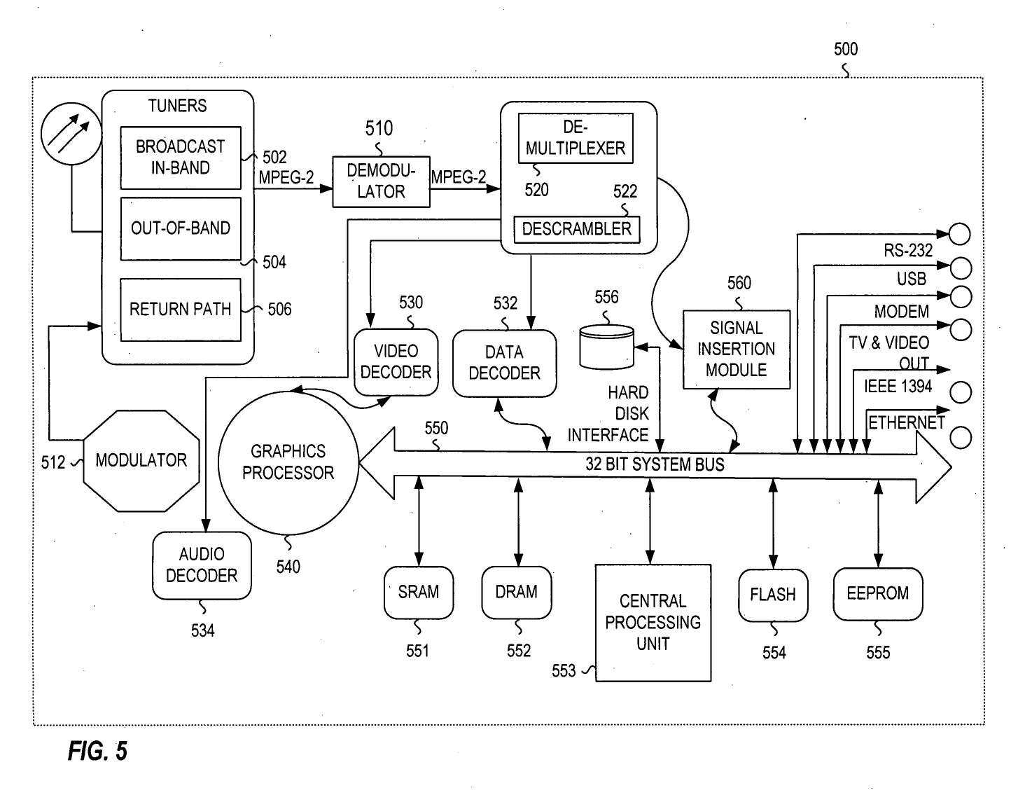

FIGS. 4 and 5 illustrate an overview of some of the important processes entailed in the extraction, decoding and presentation of a particular program, at the set-top receiver, of an MPEG-2 transport stream according to one embodiment of the present invention. As illustrated in FIG. 4, the transport stream 436 is “demuxed” by a transport demultiplexer 442 (which includes a clock extraction mechanism), unpacketized by a depacketizer 450, and sent for audio and video decoding to an audio decoder 462 and a video decoder 460 respectively. These activities are managed by a system processor. The decoded signals are sent to respective buffer and presentation units 470 that output the video 472 and audio 474 to a display device (not shown) and speaker (not shown) at the appropriate times. The timing and synchronization of presentation of decoded output is accomplished utilizing the Program Clock Reference (PCR), carried in the transport stream and as well as the Presentation Time Stamps (PTSs). Recall that multiple PES streams, corresponding to multiple programs, get multiplexed together along with appropriate System Information/Program Specific Information (SI/PSI) to form a transport stream. Upon first receiving a transport stream, the demultiplexer must look for PIDs 0 and 1 in the packet headers. All PID 0 packets contain the Program Association Table (PAT). All PID 1 packets contain Conditional Access Table (CAT) data. By reading the PAT, the demux can find the PIDs of the Network Information Table (NIT) and of each Program Map Table (PMT). By finding the PMTs, the demux can find the PIDs of each elementary stream.

FIG. 5 is a block diagram of a set-top box (STB) 500 configured in accordance with the principles of the present invention. The STB 500 includes various tuners 502, 504, 506; a modulator 512; a demodulator 510; a demultiplexer 520; a descrambler or decryptor 522; a video decoder 530; an audio decoder 534; a data decoder 532; a graphic processor 540; a Central Processing Unit (CPU) 553; memory 551, 552, 554, 555; a storage device 556; and a Signal Insertion Module 560 (the insertion signal may also be input to the MPEG decoder as a compressed stream).

An example of operation in the digital cable environment is as follows. The STB 500 receives transport streams via an audio/visual cable, coax cable, an S-video or other appropriate connection. These transport streams may be multiplexed and carried within conventional 6 MHz NTSC channels. When a program or “channel” is selected by a subscriber, a tuner 502 selects the appropriate NTSC channel (that contains the program of interest). The received signal is demodulated by the demodulator 510, and then demultiplexed by the demultiplexer 520. The demultiplexer 520 uses the Program Specific Information (PSI), to extract the correct packets, from the multiplex, with which to recreate the desired program stream. The PSI includes the PAT and the PMT. The PAT has a PMT packet identifier (PID) for all programs, and each PMT has, inter alia, the video and audio PID information for a particular program. The demultiplexer 520 uses the information in the PAT and PMT to recalculate the new program stream and select the appropriate audio, video and data channels. These are directed to the appropriate decodes where they are decoded and directed to the output display device.

When a channel change (or other event associated with a display delay) occurs, the signal insertion module is notified, which then directs one or more local signals to the display device. In a preferred embodiment, the display of the local signal begins at the point when the display from the previous channel terminates. As explained above, a currently displayed program generally will not be interrupted at an arbitrary point (e.g., at a random channel change), but in order to maintain a satisfactory and aesthetically pleasing transition, will continue to be displayed until, for example, and I-frame or end of a group-of-pictures (GOP) is reached in the MPEG stream. It is at this point, that the local signal will begin being displayed.

The Signal Insertion Module 560 requests a local memory signal from a STB memory 556. The local signals that reside in STB memory 556 may be preloaded. These signals may be audio, video, or any sort of multimedia data. In addition, these local signals may be updated periodically to the STB 500. In this embodiment, a method of downloading updated signals exists to keep these local signals current. Signals may be delivered periodically, e.g., every week, Monday at 0800, over broadcast networks such as cable television (CATV), over-the-air broadcast systems, and switched digital access systems which use telephone company twisted wire pairs for the delivery of data.

The request for local signals may be made in the form of a request message. In one embodiment of the present invention, the Signal Insertion Module 560 directs a local signal from the STB memory 556 to the television until the new program stream from the decoders overwrite it. In this embodiment, the program stream from the video decoder 530 always has a higher priority over the local signal direct by Signal Insertion module 560.

In one embodiment of the present invention, these signals could be in the form of advertisements. The advertisement could be updated periodically to eliminate redundancy.

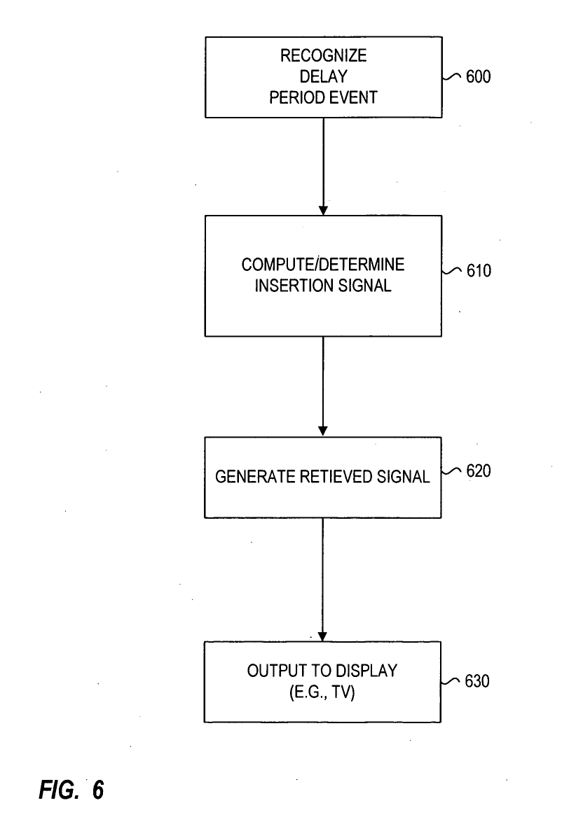

FIG. 6 is a flowchart illustrating an exemplary process for inserting signals into the delay period associated with channel changes. The present invention provides for a watchdog module or processor that monitors events within the STB 500. The Recognize Delay Period Event process 600 continually monitors the system for events that would entail a delay period such as a channel change. In the present invention, once a channel change (or other delay associated event) is detected, the signal insertion process begins. The Compute and Determine Insertion Signal process 610 determines the appropriate signal or signals to be selected for insertion and the timing of the insertion. The actual signal and timing of the signal will be determined from the type of change event. For instance, with a channel change event, the signal may be a static advertisement and the beginning of the display of the inserted signal would be calculated to coincide with, for example, the next I-frame in the program being tuned from. The Generate/Retrieve Signal generates (or causes to be generated) or retrieves one or more appropriate (as determined in the previous step) signals to be output to the display during delay. The signal is output to the preferred display device 630, in this example, a television. In this example of a channel change, the new program is automatically displayed, as soon as it is ready for presentation, overwriting the advertisement (or the termination of the ad display is coincident with the display of the new program.

The principles of the present invention may be used in a plurality of applications, including audio, visual, and graphics signals. Generally, one or more different types of signals may be inserted to better utilize the delay period.

In one embodiment, the signals inserted are audio signals containing spot advertisements. In another embodiment, the signals are video signals containing graphics/pictures relating to the advertisements. It is to be noted that the principles of the present invention are flexible, e.g., graphics signals may be used to present visual effects related to the advertisements. For example, as the subscriber changes channel from Number 6 to Number 3, a graphic visual may be created and a spot advertisement may be shown. The advertisement may only last for a few seconds and yet effectively promote the advertised products and services.

Although this invention has been described relating to inserting ads and other material for display during the delay encountered during channel changes in MPEG-2 receiver, the invention extends to, and is clearly meant to encompass, other situations where delays in display are encountered. Such delays may be a result of the MPEG-2 program selection and decoding as described above, but could also be due to any other aspect of the receiver processing that results in a delay or gap in what is displayed on the output device (e.g., TV). For example, utilizing personal video recorders (PVRs), such as those provided by ReplayTV™ and TiVO™, introduce noticeable delays during channel changes due to increased processing overhead (i.e., time) in addition to that of the MPEG-2 channel acquisition. Furthermore, although the problem to be solved by the present invention has been described in terms of delays in display encountered during television programming, the invention is just as applicable to delays encountered in or during other forms and aspects of the television viewing environment. Examples of such other aspects include invoking and navigating the interactive program guide (IPG) and the many functions and features that can be utilized in an interactive TV system such as accessing a website (e.g., downloading a web page).

Although this invention has been illustrated by reference to specific embodiments, it will be apparent to those of ordinary skill in the art that various changes and modifications may be made that clearly fall within the scope of the invention. The invention is intended to be protected broadly within the spirit and scope of the appended claims.

I/We claim:

1. A method for inserting one or more local signals and for reallocating bandwidth during an inherent delay period associated with a changing from a first video stream to a second video stream in a digital television environment, the method comprising:
(a) receiving a first video stream that occupies a first bandwidth;
(b) receiving a request for a second video stream that occupies a second bandwidth;
(c) recognizing the inherent delay period associated with execution of the request for the second video stream, wherein the inherent delay period is the time to acquire and decode a digital video signal;
(d) generating a request for a local signal, wherein the local signal is stored in memory;
(e) inserting the local signal during the inherent delay period; and
(f) reallocating the first bandwidth and at least a portion of the second bandwidth during the inherent delay period, such that data not associated with the first video stream or the second video stream may be received.

2. The method of claim 1 further comprising:
(g) manipulating the inherent delay period such that the second video stream is delayed until the local signal is terminated.

3. The method of claim 1, wherein the local signal is a targeted advertisement.

4. The method of claim 1, wherein the local signal is an audio signal.

5. The method of claim 1, wherein the local signal is a graphics signal.

6. The method of claim 1, where the local signal is an HTML page, either locally stored or received real-time from any source.

7. The method of claim 1, wherein the local signal is an analog television channel.

8. The method of claim 1, wherein the local signal is a locally stored MPEG stream.

9. The method of claim 1, wherein the reallocation of step (f) enables the presentation of additional advertisements.

10. The method of claim 1, wherein the reallocation of step (f) is undetectable by a viewer.

11. The method of claim 1, wherein the local signal is correlated with the second video stream.

12. The method of claim 1, wherein the content of the local signal corresponds to the content of the second video stream.
